(19) United States
(12) Patent Application Publication
(10) Pub. No.: US 2021/0229208 A1
(43) Pub. Date: Jul. 29, 2021

(54) ULTRAVIOLET RADIATION SENSING AND BEAM CONTROL IN ELECTRON BEAM ADDITIVE MANUFACTURING

(71) Applicant: DIVERGENT TECHNOLOGIES, INC., Los Angeles, CA (US)

(72) Inventors: Eric Yang, Los Angeles, CA (US); Andrius Juozas Raulinaitis, Los Angeles, CA (US); Michael James Hoganson, Los Angeles, CA (US)

(21) Appl. No.: 16/752,378

(22) Filed: Jan. 24, 2020

(51) Int. Cl. B23K 15/00; B33Y 10/00; B33Y 30/00; B33Y 50/02; B23K 15/02; B23K 15/06; G01J 1/42; G01J 1/04

(52) U.S. Cl. CPC B23K 15/0086; B33Y 10/00; B33Y 30/00; B33Y 50/02; B23K 15/0026; G01J 1/0411; B23K 15/02; B23K 15/06; G01J 1/429; G01J 1/0425; B23K 15/002

(57) ABSTRACT

In various aspects, an apparatus for an electron-beam powder bed fusion (EB-PBF) printer includes a radiation collector configured to collect radiation in an ultraviolet (UV) spectrum at a powder bed surface within a vacuum chamber during an electron beam scanning cycle of EB-PBF operation, an optical fiber configured to be transparent to the radiation in the UV spectrum and configured to receive the radiation at the powder bed surface via the radiation collector, and a processor configured to receive one or more extracted wavelengths of radiation in the UV spectrum based on the radiation carried on the optical fiber.

### BACKGROUND

### Field

The present disclosure relates generally to additive manufacturing systems, and more particularly, sensing ultraviolet (UV) radiation during electron beam scanning cycles in additive manufacturing systems.

### Background

Additive manufacturing (AM) systems, also described as 3-D printer systems, can produce structures (referred to as build pieces) with geometrically complex shapes, including some shapes that are difficult or impossible to create with conventional manufacturing processes. AM systems, such as electron beam (EB) powder bed fusion (PBF) systems, create build pieces layer-by-layer in a vacuum chamber. Each layer or ‘slice’ is formed by depositing a layer of powder on a powder bed during a re-coat cycle, and then exposing portions of the powder to an electron beam during a print scanning cycle. During the scanning cycle, the electron beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up.

### SUMMARY

Several aspects of apparatuses and methods for sensing ultraviolet (UV) radiation during electron beam scanning cycles in additive manufacturing systems will be described more fully hereinafter.

In various aspects, an apparatus for an electron-beam powder bed fusion (EB-PBF) printer includes a radiation collector configured to collect radiation in an ultraviolet (UV) spectrum from a powder bed surface within a vacuum chamber during an electron beam scanning cycle of EB-PBF operation, a UV wave guide, such as an optical fiber configured to be transparent to the radiation in the UV spectrum and configured to receive the radiation at the powder bed surface via the radiation collector, and a processor configured to process one or more extracted wavelengths of the radiation in the UV spectrum based on the radiation carried on the optical fiber.

In various other aspects, a powder bed fusion apparatus includes an electron beam source configured to selectively fuse at least one layer of powder provided on a surface of a vacuum chamber; and a UV assembly within the vacuum chamber and including: a radiation collector configured to receive UV radiation from the at least one layer of powder when the electron beam source selectively fuses the at least one layer of powder, a UV-transparent optical fiber configured to receive the UV radiation from the radiation collector, and at least one interface configured to provide at least a portion of the UV radiation to a processor.

In various further aspects, a method for an EB-PBF printer includes collecting, by a radiation collector, radiation in a UV spectrum from a powder bed surface within a vacuum chamber of the EB-PBF during an electron beam scanning cycle of EB-PBF operation; receiving, by an optical fiber configured to be transparent to the radiation in the UV spectrum, the radiation in the UV spectrum from the powder bed surface via the radiation collector; and processing, by a processor, one or more extracted wavelengths of the UV radiation based on the radiation carried on the optical fiber.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of sensing ultraviolet (UV) radiation during electron beam scanning cycles in additive manufacturing systems will now be presented in the detailed description by way of example, and not by way of limitation, in the accompanying drawings, wherein:

FIGS. 1A-D illustrate an example powder bed fusion (PBF) system during different stages of operation.

FIG. 2 illustrates an example PBF apparatus including a radiation collector for measuring ultraviolet (UV) radiation and PBF apparatus parameter variation with closed-loop control.

FIG. 3 is a perspective view of a vacuum chamber of an electron beam (EB) powder bed fusion (PBF) apparatus with a radiation collector adjacent the electron beam source.

FIG. 4 is a cross-sectional perspective view of a UV system having a radiation collector for use in an EB-PBF system.

FIG. 5 is a block diagram illustrating an example EB-PBF system including a radiation collector coupled to an optic fiber in a vacuum chamber, and a processor that receives UV radiation carried on the optic fiber.

FIG. 6 is an example view of a radiation collector for collecting UV radiation.

FIGS. 7A-B illustrate example embodiments of a radiation collector coupled to a shielding component for selectively receiving UV radiation.

FIG. 8 illustrates a view of an example configuration of a radiation collector including a plurality of layers for collecting UV radiation.

FIG. 9 illustrates a perspective view of an example radiation collector and shielding component using rollers.

FIG. 10 illustrates an example method of sensing UV radiation in an EB-PBF system.

### DETAILED DESCRIPTION

The detailed description set forth below in connection with the appended drawings is intended to provide a description of various example embodiments of the concepts disclosed herein and is not intended to represent the only embodiments in which the disclosure may be practiced. The terms “exemplary” and “example” used in this disclosure mean “serving as an example, instance, or illustration,” and should not necessarily be construed as excluding other possible arrangements or as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

In EB-PBF systems, selecting the proper electron beam intensity, scanning rate, and other printer parameters is important in order to print build pieces with the desired qualities. Adjustments to the printer parameters and other modifications can be made in between printing runs (i.e., after a build piece is completely printed), for example, based on a trial and error approach. However, if certain characteristics of the powder bed surface could be measured during printing, it may be possible to adjust printer parameters during printing based on the measured characteristics. Therefore, accurate determinations of characteristics associated with the powder bed surface, such as material composition of the powder bed, or other EB-PBF component may be particularly useful to ensure accurate production of build pieces, which may be subject to rigorous quality control.

Such measurements are in practice difficult to accurately obtain, in part due to the chaotic environment of the vacuum chamber during a scanning cycle. For example, one way to make such measurements would include placing a radiation collector inside the vacuum chamber to collect radiation from the powder bed for processing to determine characteristics of the powder bed. However, powder particles can be vaporized by the electron beam, and the vapor can quickly condense on a surface of the radiation collector, compromising measurement integrity. Incorrect measurements may consequently prevent the EB-PBF system from accurately adjusting various process states (e.g., the electron beam intensity or the scanning rate) and/or may otherwise hinder the quality and integrity of the build process. Therefore, a need exists for accurately determining information about the material composition of the powder bed and/or build process.

This disclosure is directed to sensing ultraviolet (UV) radiation in an electron beam powder bed fusion (EB-PBF) system and the dynamic determination of system characteristics and/or material composition based thereon. While the concepts and embodiments of the present disclosure may apply to other additive manufacturing systems, the embodiments as described herein are in the context of EB-PBF systems. Further, the present disclosure includes descriptions in the context of UV radiation, which has a spectral range of approximately 10 nanometers (nm) to 400 nm; however, the concepts and embodiments described herein may apply to visible light, e.g., including wavelengths from approximately 380 nm to approximately 740 nm.

EB-PBF systems generally include a vacuum chamber in which a powder bed is arranged. An electron beam source is positioned over the powder bed. During a re-coat cycle, a depositor, hopper, or other re-coat mechanism deposits powder in the powder bed. A leveler, such as a specially shaped blade, may be used to pass over the powder bed surface to spread the deposited powder into an evenly shaped layer. After the powder layer is deposited, a scanning cycle may occur in which the electron beam, based on instructions from a print controller, selectively scans or fuses portions of the deposited layer to form a weld pool that quickly solidifies into an intended cross-section of the build piece being printed. The instructions from the print controller can be based on various printer parameters.

More than one build piece may be printed per run, depending on considerations like the relative sizes of the build pieces, the powder bed, and build chamber volume. These considerations are largely accounted for in an earlier computer aided design (CAD) process conducted prior to the run, wherein a designer renders a three-dimensional computer model or representation of the build piece(s). The CAD designs are compiled over the course of a few intermediate steps (e.g., supports may be generated where necessary to support overhanging portions of the build piece during printing, etc.). Ultimately the CAD designs are compiled into instructions that are compatible with and decipherable by the 3-D printer. For simplicity in this disclosure, a single build piece is illustrated. In addition, while the principles of this disclosure are described in the context of a single electron beam source, the disclosure is equally applicable to a 3-D printer having multiple beam sources and/or multiple radiation collectors (described below).

As briefly noted above, the electron beam source may be coupled to a print controller or other processor that executes the instructions to render the build piece. For example, the instructions may instruct the depositor and leveler to deposit and level layers of powder during a re-coat cycle. The instructions also selectively manipulate the electron beam source during the following fusing or “scanning” cycle to fuse cross-sectional areas of the power layers to create a small section (i.e., a layer) of the overall build piece.

After the electron beam source has completed the current scanning cycle, another re-coat cycle is conducted and a further layer is deposited over the existing layer in the manner described above. This sequence of scanning and re-coat cycle continues to repeat until the requisite number of layers are deposited and the build piece is formed. Thereafter, the build piece and the loose powder particles can be removed from the vacuum chamber of the EB-PBF printer and the powder bed can be prepared for another run.

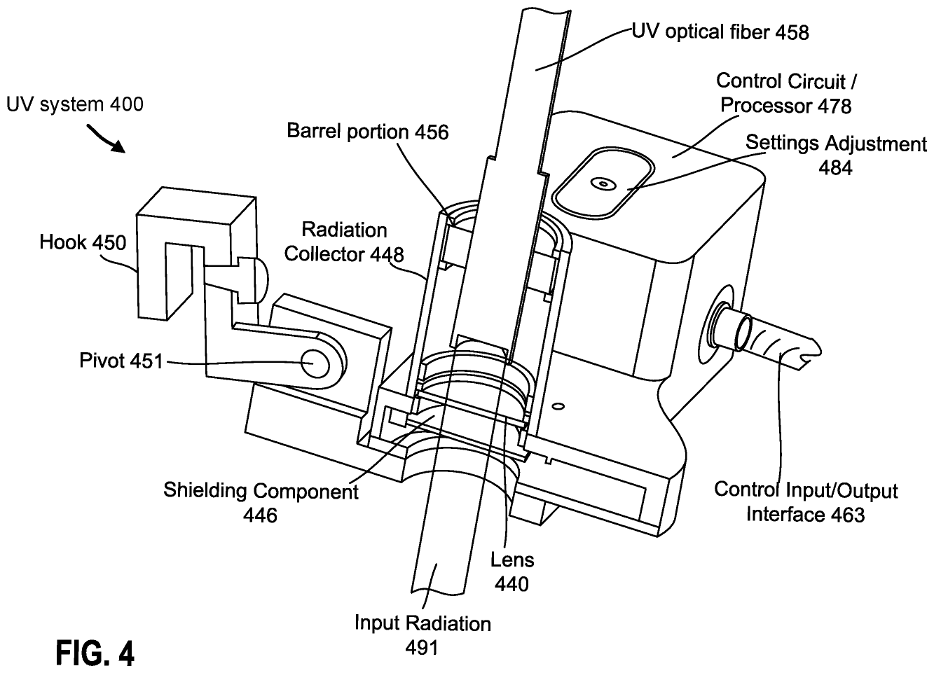

In various embodiments, a radiation collector portion of a UV optical apparatus is arranged within the vacuum chamber and positioned above a surface of the powder bed. The radiation collector may include a lens, receiver electronics, and a barrel portion (FIG. 4) coupled to a wave guide, such as a fiber cable, for example, for transmitting radiation. For example, the radiation collector may include a lens or other UV-transparent material that can concentrate radiation onto a wave guide attached to the barrel portion, and the received radiation is passed from the radiation collector to the wave guide.

In various embodiments, the lens or other UV-transparent material may concentrate radiation received during the 3-D printing process (i.e., during a re-coat cycle and/or a scanning cycle) onto the wave guide. The wave guide may thereafter carry the radiation through an interface in a wall of the vacuum chamber and to a processor for selecting desired UV wavelengths or ranges thereof and for measuring one or more characteristics of a powder bed surface using the received radiation.

The radiation collector may be located in different portions of the vacuum chamber and may be positioned to receive radiation from any portion of the powder bed surface. Depending on the configuration of the radiation collector, the radiation received from a surface of the powder bed may initially include a spectral region that broadly includes the UV spectrum and, potentially, portions of adjacent spectra (e.g., visible light and/or infrared (IR) and near-IR). In this configuration, the radiation may be sent to a processor configured for extracting the desired (UV) wavelengths from the radiation. In this case, the wave guide can be a wave guide configured to transmit radiation in a broad range of wavelengths, including UV radiation. In various embodiments, the radiation collector may use transparent and/or sacrificial elements, one or more UV-transparent materials (e.g., films), and/or one or more specialized lenses, to extract the desired UV radiation. In the latter configuration, the wave guide carries only the UV portion of the radiation to the processor. In this case, in various embodiments, the wave guide can be a UV wave guide that is configured to transmit only UV radiation. Even if only UV radiation is transmitted to the processor, in various embodiments the processor may further extract specific UV wavelength ranges from the UV radiation. For example, a wavelength division multiplexer (mux)/demultiplexer (demux), which may be included in the processor or may be a separate circuit element communicatively connected to the processor, may be configured to extract specific UV wavelength ranges from UV radiation.

The wave guide receives the UV radiation in the vacuum chamber and carries it to an external region having a generally normal atmospheric pressure (e.g., approximately 1 standard atmosphere (atm) at sea level) outside the vacuum chamber. In other embodiments, the processor and other circuits may be located within the vacuum chamber. The processor may include various electronic circuits for processing and/or filtering the UV radiation, and a transducer (such as a photo-diode array) for converting the radiation into an electrical signal. In various embodiments, the radiation may include one or more wavelength ranges in the UV region of the electromagnetic spectrum.

In various embodiments, the processor may include one or more general purpose central processing units (CPUs) having registers and cache memory. In various embodiments, the processor may include one or more dedicated circuits, such as Application Specific Integrated Circuits (ASICs), programmable array logic, digital signal processors, multiplexors, decoders, Boolean logic circuits, or the like.

UV spectral information received by the radiation collector and processed by the processor may include a variety of characteristics that can be used by the processor or by a main print controller to determine, for example, process states and/or deviations from material compositions (e.g., the material provided as powder for PBF), or more broadly, any relevant surface characteristic that can be determined from the UV radiation. Examples of such characteristics may include, without limitation, temperature, the spectral composition of materials at the relevant portions of the powder bed, the amount of powder vapor affecting the scanning beam, the presence or absence of magnetic or electric fields and their amplitudes and polarization, and any other characteristics that are measurable and that may be used to improve the accuracy of the 3-D print process. In various embodiments, information associated with the powder bed surface that is determined by the processor, such as composition information for example, can include information of the loose powder in the powder bed and/or information of the melted powder in the powder bed.

In an embodiment, the processor can change one or more printer parameters on the fly based on information determined from the UV radiation. In another embodiment, the processor can send UV-related information or other characteristics determined therefrom to a process controller or a print controller (which may include one or more processors and/or code sets running thereon, depending on the 3-D printer type and configuration). The process or print controllers may in turn issue instructions to change one or more printer parameters of the 3-D print job in or near real time upon receipt of the information determined from the UV radiation. For instance, the print controller may dynamically adjust the beam intensity based on information derived from UV radiation information. In this manner, the 3-D printer can use the processor in a dynamic feedback loop to change various printer parameters responsive to determining the UV radiation information. Specifically, UV radiation information may be used for quality monitoring to determine deviations of material compositions and/or one or more sets of mathematical and/or heuristics functions may be used to derive control signals, e.g., potentially to alter various printer parameters on a layer-by-layer basis or on a continuous basis. Such quality monitoring and alterations may maximize material properties and/or ensure process consistency. By way of illustration, the print controller may reduce the beam intensity, increase the scanning rate, etc. By way of converse illustration, the print controller may increase the intensity of the electron beam. Based on one or more characteristics derived from UV radiation measurements, the print controller may dynamically increase or decrease the scanning rate or change other settings to maximize the print quality. The radiation collector may be used to extract information from UV wavelengths in the UV radiation and to thereby identify a various characteristics of the powder bed surface from which the UV radiation was collected. The processor that receives this information may determine characteristics directly from the UV radiation, or it may indirectly infer one or more characteristics based on information included in one or more spectra within the UV range. The processor may also take multiple measurements over time and may build a profile or histogram of data. The processor may analyze the UV frequency spectrum and extract relevant results from the profile or histogram of data, as well.

In various embodiments, a printer parameter (or multiple printer parameters) of a PBF system can have different values at different times during a slice printing operation. For example, the scanning rate of the energy beam can be faster across one area of a powder layer and slower across another area of the powder layer. In some embodiments, the temperature may be different in fused locations or weld pools during the printing. The processor can determine UV radiation information either in real time or during a re-coat cycle to capture these changes in measurements, and the print controller can make the appropriate adjustments, either in near real-time or in the next scanning cycle.

In EB-PBF printers, the vacuum nature of the environment generally causes significant difficulties in channeling information outside the vacuum chamber. For example, X-rays cannot be carried on UV optical fibers and, therefore, cannot be easily channeled outside of the vacuum chamber. One of the advantages of using the UV spectrum based on a plurality of selected wavelengths is that UV radiation can be carried on UV optical fibers, which facilitates channeling outside of the vacuum chamber. Furthermore, UV radiation may provide information regarding the interactions between trace atmosphere and/or other material or trace interactions at the fusing site. This and other information may be inaccessible or absent from radiation in other spectra, such as X-ray radiation. As discussed above, a feedback loop can be created where the processor or print controller can elicit the information and feed the information forward to the next layer to adjust speed, current, focus, or other printer parameters to maintain a well-controlled overall process. In various embodiments, as discussed above, the radiation collector can collect the UV radiation on the fly, and provide the output to the processor. The processor can then elicit various characteristics from the radiation and can either adjust certain printer parameters in one embodiment, or it can forward the characteristics to the print controller in another embodiment. In either embodiment, the processor or print controller can adjust printer parameters such as the intensity of the electron beam, the electron beam focus, the scanning rate, etc. in or near real time. As noted, in some configurations, one processor may be used to accomplish these tasks. Other embodiments may involve multiple processors.

One challenge in taking measurements during the scan cycle is that during the scan, the electron beam may vaporize powder and the resulting vapor may condense, which may interfere with the radiation collector and/or other components. As an illustration of this problem, it is generally understood that when metal materials are heated in vacuum, the materials tend to boil. If the vacuum chamber gets to a certain threshold temperature, metallic particles at the atomic level may begin to randomly spatter other sections of the chamber. As such, if a radiation collector is active during the print scanning cycle, stray particles may vaporize and the resulting vapor is likely to condense on the surface of the lens or other UV-transparent material in use. The result is that the measurements of the UV energy become inaccurate, and so too do the determinations of UV-based printer parameters.

However, it may be desirable to collect UV radiation during an electron beam scanning cycle (i.e., when the electron beam strikes the powder) at the point at which the electron beam strikes the powder (i.e., the weld site). Solutions to the spattering problem are introduced through the use of a shielding component proximate and/or connected to the radiation collector. For example, during vulnerable periods for the radiation collector such as when the electron beam is angled to strike the powder bed surface directly beneath the radiation collector, the control circuitry adjacent the radiation collector (or in other embodiments, the processor) may adjust the shielding component to partially or entirely cover the lens with a UV-transparent material.

In various embodiments, the radiation collector may use one or more UV-transparent materials that selectively reject non-UV frequencies. The shielding component may operate to expose a small portion of the UV-transparent material so that the radiation collector can collect UV radiation, while the remaining portion of the UV-transparent material is covered. For example, as illustrated in greater detail below, the shielding component may include a mechanism that advances a strip of UV-transparent film such that any given region of the UV-transparent film is used for a specified but limited period of time, after which the shielding component advances the strip to expose a clean region for making new measurements, while masking the remaining regions of the strip.

In similar embodiments, more than one glass, film or other UV-transparent layer may be used. For example, the UV-transparent materials of the radiation collector may be stacked over one another such that geometrical sections of the outermost layer aligned with the radiation collector are progressively advanced over a plurality of time intervals to capture loose particles while the lens or materials underneath are kept free of condensation. Then, before condensation of vapor due to the powder vaporization on the existing outermost layer/section becomes a significant problem, the outermost layer can be advanced (moved) into an area underneath another portion of the shielding component, while a new section of the transparent outermost layer is concurrently made available. Using the new section of UV-transparent material, the radiation collector can take accurate readings of the radiation until the buildup of particles on the outer layer necessitates that the layer yet again be advanced to reveal still another new section. In other embodiments, the outermost layer may simultaneously constitute a UV layer itself, without the need for stacked layers.

Using one or more of the foregoing embodiments of a shielding component, or another embodiment configured to provide substantially the same condensation protection, may facilitate accurate measurements of UV radiation in the chamber while protecting the radiation collector and preventing condensation or other contaminants from impairing UV-radiation collecting by the radiation collector.

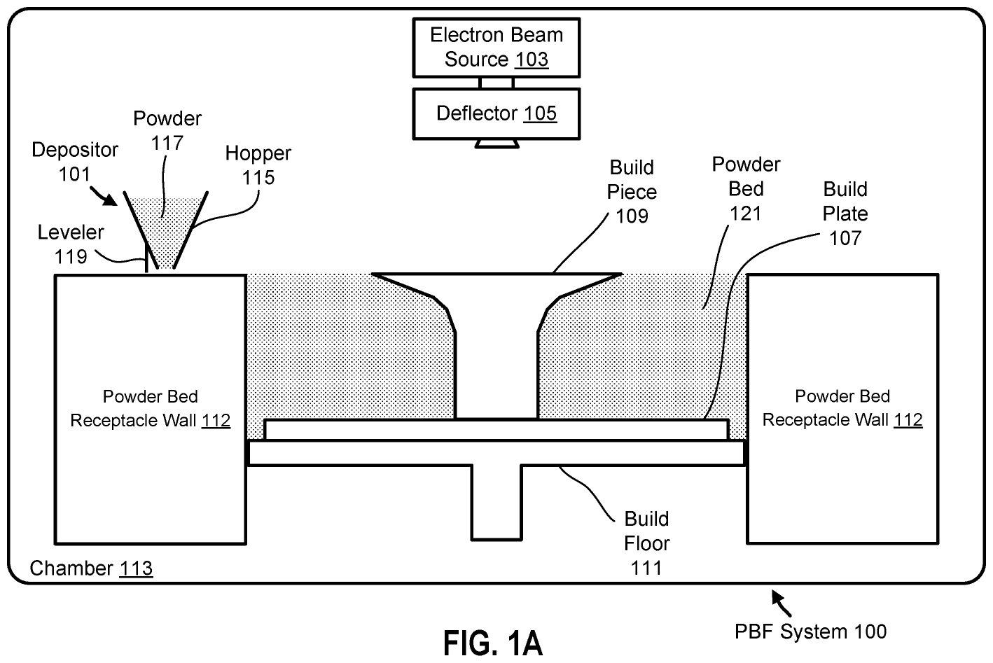

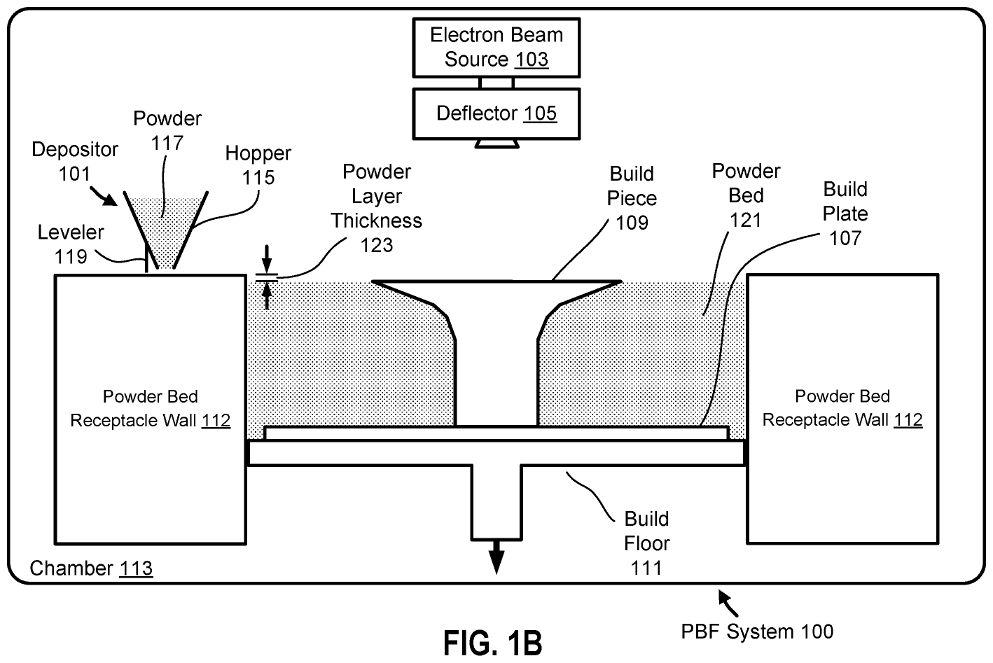

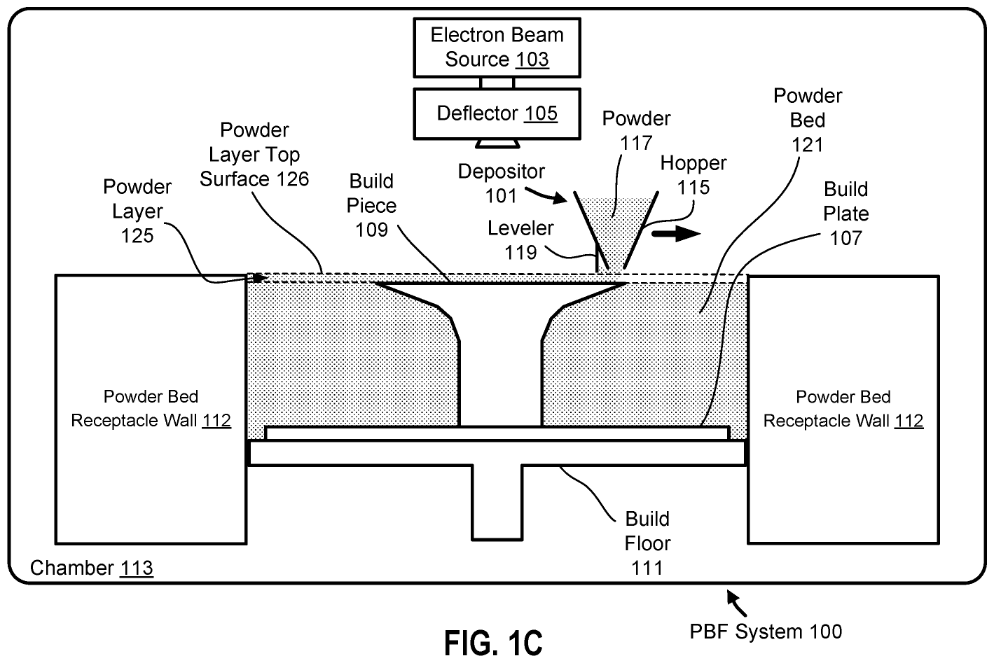

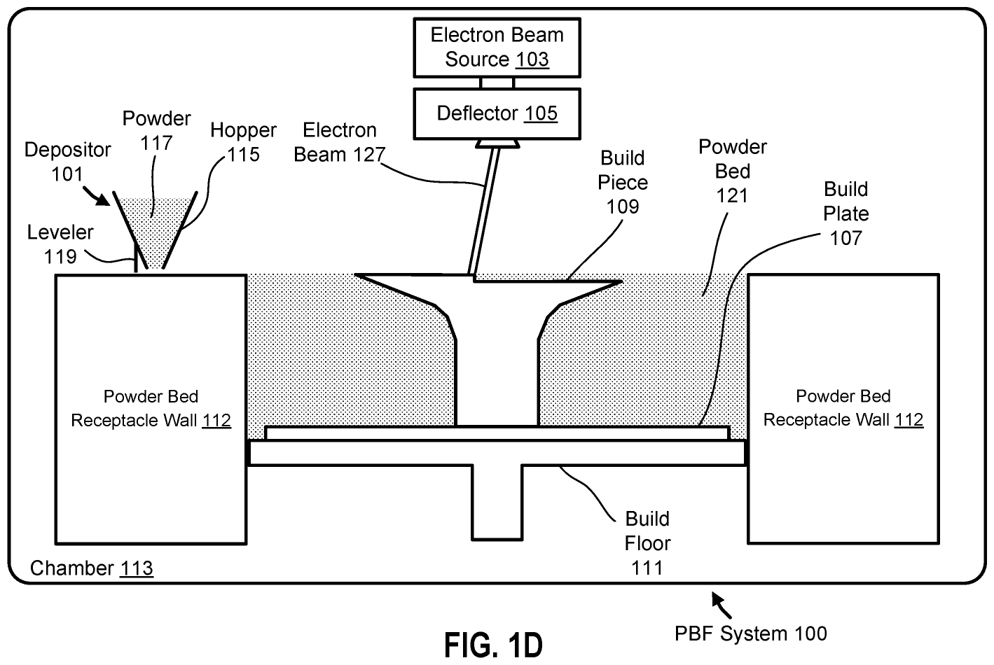

FIGS. 1A-D illustrate respective side views of an example PBF system 100 during different stages of operation. As noted above, the particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an electron beam source 103 that can generate an electron beam, a deflector 105 (such as a plurality of magnets) that can apply the electron beam to fuse the powder material, and a build plate 107 that can support one or more build pieces, such as a build piece 109. PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, as well as enabling temperature regulation, quality control, and process consistency, in the vacuum chamber that encases the powder bed and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 during the re-coat cycle, where depositor 101 is positioned to deposit powder 117 in a space created over the top of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B) and that has a powder layer top surface 126 that is substantially flat. Thus, the powder in a PBF system can be supported by a powder material support structure, which can include, for example, a build plate 107, a build floor 111, a build piece 109, walls 112, and the like. It should be noted that for clarity, the illustrated thickness of powder layer 125 (i.e., powder layer thickness 123 (FIG. 1B)) is shown greater than an actual thickness used for the example involving 150 previously-deposited layers discussed above with reference to FIG. 1A.

FIG. 1D shows PBF system 100 at a scanning cycle after the re-coat cycle in which, following the deposition of powder layer 125 (FIG. 1C), electron beam source 103 generates an electron beam 127 and deflector 105 applies the electron beam to fuse the next slice in build piece 109. Deflector 105 can include deflection plates that can generate an electric field or a magnetic field that selectively deflects the electron beam to cause the electron beam to scan across areas designated to be fused.

In various embodiments, the deflector 105 can include one or more gimbals and actuators that can rotate and/or translate the electron beam source to position the electron beam. In various embodiments, electron beam source 103 and/or deflector 105 can modulate the electron beam, e.g., turn the electron beam on and off as the deflector scans so that the electron beam is applied only in the appropriate areas of the powder layer. For example, in various embodiments, the electron beam can be modulated by a digital signal processor (DSP).

The operations of a PBF system, such as depositing the powder layer, generating the electron beam, scanning the electron beam, etc., are controlled based on the printer parameters of the PBF system. Responsive to information elicited from one or more UV wavelengths, these printer parameters may be modified to maintain optimal printing conditions and to thereby maximize quality and integrity of the resulting build piece.

For example, one such parameter is the power of the electron beam generated by the electron beam source. In various PBF systems, the beam power parameter may be represented by, for example, a grid voltage of an electron beam source, a wattage output of a laser beam source, etc. Another example of a parameter is the scanning rate of the deflector, i.e., how quickly the deflector scans the electron beam across the powder layer. The scanning rate parameter can be represented, for example, by a rate of change of a deflection voltage applied to deflection plates in an electron beam PBF system. Another example of a system parameter is the height of a powder leveler above a top surface of a previous powder layer, which can be represented as a distance of extension of the leveler, and which can determine the thickness of the next powder layer.

Values of these printer parameters may vary with time. In various embodiments, at least one of the printer parameters has a first value at a first time during a slice printing operation, i.e., the time period beginning at the start of the depositing of the layer of powder, and ending at an end of the fusing of the layer at various locations, and has a second value different than the first value during the slice printing operation. For example, a PBF apparatus can include a depositor that deposits a layer of a powder material based on a first subset of printer parameters (e.g., powder leveler height, composition of the deposited material, etc.), an electron beam source that generates an electron beam based on a second subset of the printer parameters (e.g., beam power), and a deflector that applies the electron beam to fuse the layer at multiple locations based on a third subset of the printer parameters (e.g., scanning rate), and at least one of the printer parameters can have different values during the slice printing operation. UV measurements may be taken at different time periods and compared. Any one of these sets of printer parameters may be modified in response to the UV measurements. In addition, the UV spectra may be analyzed to evaluate the beam energy at different UV frequencies, and the first and second values of the printer parameters may be modified during the printing operations.

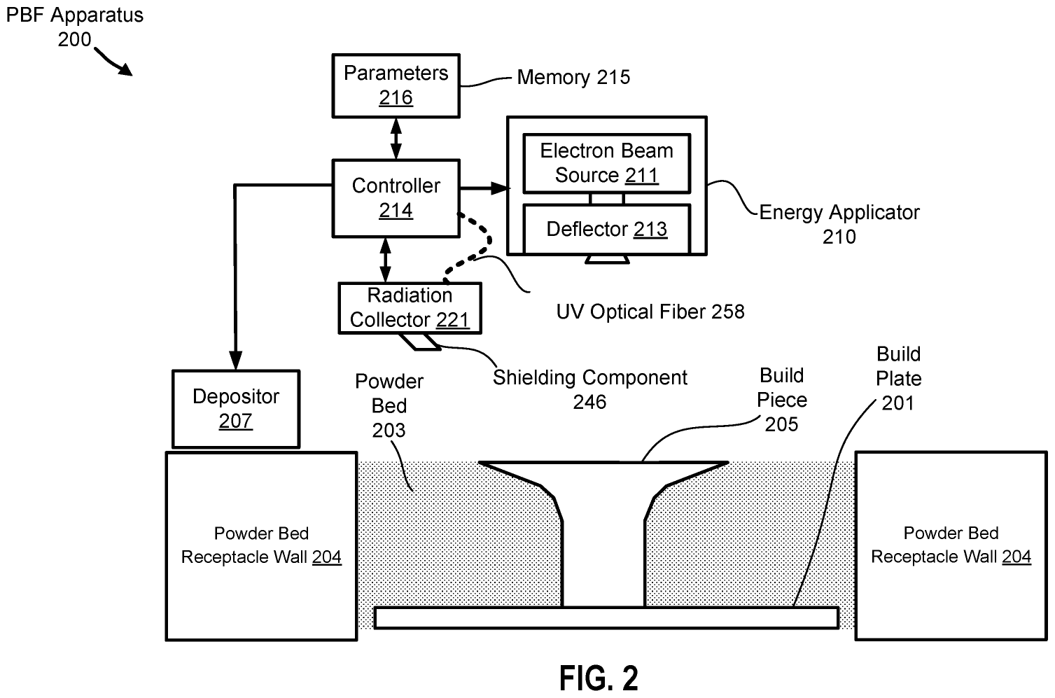

FIG. 2 illustrates an example PBF apparatus 200. In some embodiments, PBF apparatus 200 is configured for printer parameter variation with closed-loop control. Printer parameter variation may include, for example, reducing or increasing an intensity of the electron beam, and other actions described herein. In some other embodiments, PBF apparatus 200 is configured for data collection and analysis. For example, during the manufacture of a build piece 205, PBF apparatus 200 may be configured to contemporaneously collect data associated with process states, as well as data associated with build piece 205 and/or a powder bed 203 used in the manufacture thereof (e.g., data on material composition). Such collected data may be used for quality control, such as in determining deviations from material compositions. Additionally, such collected data may be used to adjust printer parameters 216 and/or otherwise configure PBF apparatus 200 for future print operations, such as by developing mathematical and/or heuristics functions designed to increase material properties and ensure consistency in the build process.

FIG. 2 shows a build plate 201, a powder bed 203 within powder bed receptacle walls 204, and build piece 205 in powder bed 203. A depositor 207 can deposit layers of material including powder material in powder bed 203 during a re-coat cycle (also referred to as a deposit cycle), and an energy applicator 210 can apply an electron beam during a scanning cycle to fuse the powder material in the deposited layers.

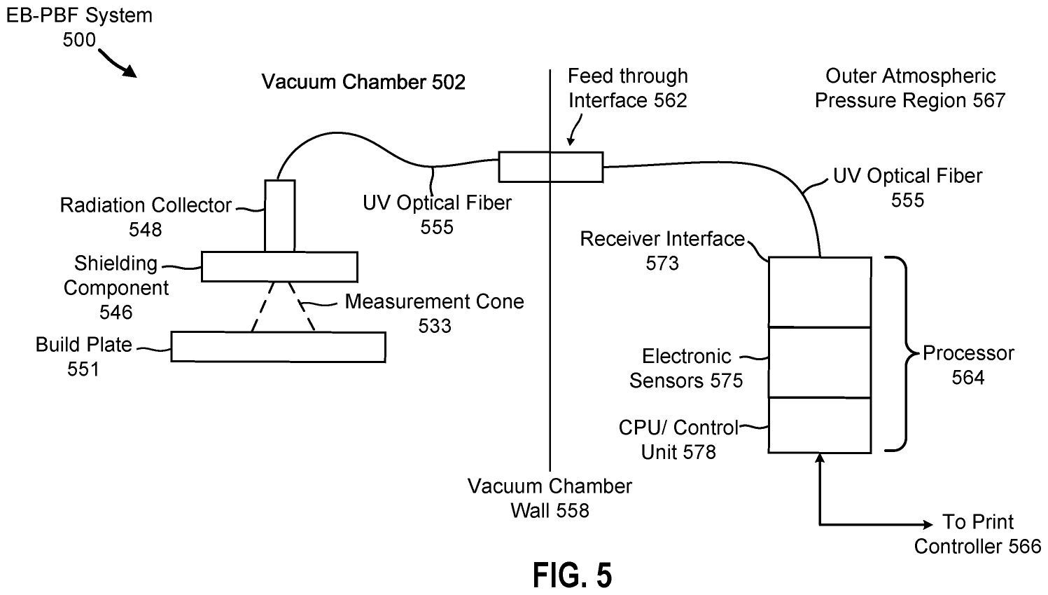

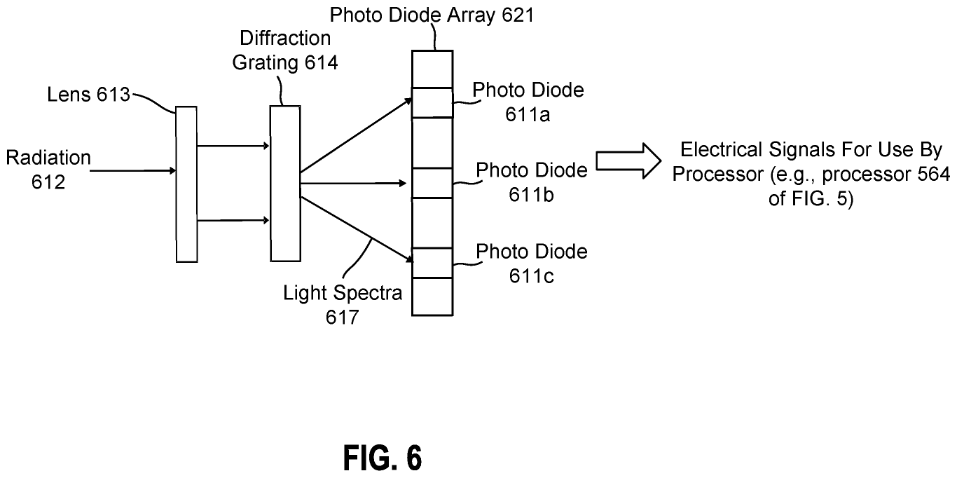

Energy applicator 210 can include an electron beam source 211 that generates an electron beam and a deflector 213 that typically uses processor-controlled sets of magnets and/or grid plates for generating electric and magnetic fields to steer the electron beam across the deposited layer. PBF apparatus 200 can also include a controller 214, which can be, for example, a computer processor. Controller 214 may, for instance, be either one or both of the print controller and the processor discussed above with reference to the sensing of UV radiation. In some embodiments, controller 214 may be a print controller for controlling principle functions of the PBF apparatus 200 such as re-coat printer parameters, scanning type, scanning speed, beam intensity, beam steering, etc. That is, controller 214 may issue instructions for directing the electron beam to move across the powder bed so as to print the structure previously modeled using computer-aided design. In some embodiments, controller 214 may be a processor that performs both general print functions and oversight of the PBF apparatus 200, and functions related to control as described further herein. In other embodiments, the processor (e.g., FIG. 5) may be distinct from the print controller. The two processing elements (e.g., controller 214 and the processor) can generally communicate via a bus or other wiring. This communication enables the print controller to modify one or more printer parameters based on information from the processor.

PBF apparatus 200 can also include a computer memory 215, such as a random access memory (RAM), computer storage disk (e.g., hard disk drive, solid state drive, flash drive), etc. Memory 215 can store parameters 216 for controlling components of PBF apparatus 200. Printer parameters 216 can include a printer parameter (or multiple printer parameters) that has two or more different values during a slice printing operation and that can be changed during operation of PBF apparatus 200. The printer parameters 216 may also be obtained during a re-coat cycle or on the fly during scanning via received UV radiation. Controller 214 can use printer parameters 216, such as the scanning rate, beam power, etc., to form each slice of build piece 205. In particular, controller 214 can control depositor 207 to deposit a layer of material, can control electron beam source 211 to generate the electron beam, and can control deflector 213 to scan the electron beam across the deposited layer in a precise manner to obtain the modeled build piece 205. Further, in various embodiments, controller 214 can control these components in the manner recited by using different determined values or types of printer parameters, and/or by using different determined subsets or combinations of printer parameters, in order to achieve a desired result for the specific printing operation at issue (such as managing overhangs, enhancing surface finish quality, optimizing printing speed, optimizing an overall combination of these and other operations, etc.).

In various embodiments, PBF apparatus 200 can include a radiation collector 221 that obtains information relating to the depositing of the layer, the fusing of the powder material, the composition of the powder material, trace interactions, as well as other information. In various embodiments, radiation collector 221 can collect UV radiation that radiates from a surface of powder bed 203 and that strikes a receiving surface of the radiation collector. For example, radiation collector 221 can include a UV-transparent lens or UV-selective material to measure the UV radiation during a print job. Additional sensors may be used for similar or different purposes, and using different technologies and devices, and the present disclosure is not limited to the collecting of UV radiation with radiation collector 221.

Radiation collector 221 can collect UV radiation in order to gather various characteristics about the vacuum environment in which the powder bed is present. For example, radiation collector 221 may receive UV radiation. Other circuits or other components may use this information to determine characteristics associated with powder bed 203, for example, including material composition and/or trace interactions. The UV spectrum may also include other information about the process, such as the frequency response of the scanning, the amount of total UV radiation, the composition of the materials and whether contaminants are present (e.g., using spectroscopy over the UV range), and similar capabilities. As noted, controller 214, or a dedicated processor circuit may elicit information in various ways from the UV spectrum. This information may be stored in memory.

In this example, controller 214 can change the values of one or more printer parameters 216 in memory 215 based on information received from radiation collector 221. For instance, radiation collector 221 can send collected UV radiation to a processor that includes a wavelength division (WD) mux/demux via a UV optical fiber 258. The WD mux/demux can select certain UV frequencies, or UV frequency ranges, from the collected UV radiation. The processor or other circuitry may use the radiation in these UV frequencies/ranges to determine information associated with a relevant portion of the powder bed 203. Using this data, controller 214 can adjust various configurations and/or printer parameters of the PBF apparatus 200 (e.g., the intensity of the electron beam), e.g., on the fly, during the next anticipated scanning cycle, or for an entirely separate build process.

Radiation collector 221 may be configured to receive radiation in the UV spectrum during a scanning cycle. That is, radiation collector 221 may collect UV radiation when energy applicator 210 controls electron beam source 211 to apply an electron beam, which causes the powder material in one or more deposited layers to fuse and disturb elements (e.g., powder and other particles). In some embodiments, radiation collector 221 may be configured to travel along a path corresponding to the point at which the electron beam strikes the surface of powder bed 203, which may also be known as the weld site. For example, controller 214 may control movement of radiation collector 221 so that an unobstructed UV optical path is maintained between radiation collector 221 and the weld site. In another example, radiation collector 221 may be connected to energy applicator 210 such that movement of energy applicator 210 causes corresponding movement of radiation collector 221.

However, the electron beam scanning cycle may cause the powder and/or other particulate elements to be ejected (e.g., from powder bed 203) in random and/or uncontrolled motions. Such uncontrolled and random particulate elements may be attributable to the volatile nature of the vacuum chamber during the scanning cycle, e.g., as an unavoidable effect of the electron beam striking the surface of powder bed 203 at high temperatures. Therefore, in some embodiments, PBF apparatus 200 may include a shielding component 246 that is proximate and/or connected to radiation collector 221. As radiation collector 221 may collect UV radiation during the electron beam scanning cycle, shielding component 246 may therefore include a UV-transparent material to protect the radiation collector (e.g., including a lens) against condensation of vapor from vaporized powder, ejected powder, and other particulate elements at radiation collector 221 (e.g., on the lens surface). In other words, shielding component 246 may be configured to reduce or eliminate interference along the UV optical path to radiation collector 221, such as interference caused by elemental condensation and/or other adulterants/contaminants that may obstruct detection of UV radiation by radiation collector 221.

To that end, shielding component 246 may be positioned between radiation collector 221 and powder bed 203; for example, shielding component 246 may be positioned substantially between radiation collector 221 and the weld site. During the scanning cycle, deflector 213 is configured to scan the electron beam across the deposited layer and, therefore, shielding component 246 may be configured to move with radiation collector 221 so that shielding component 246 maintains a position substantially between radiation collector 221 and the weld site. In some embodiments, controller 214 may control shielding component 246 to move to such a position(s), e.g., during times at which controller 214 (or a separate processor, logic, or other circuit) determines that radiation collector 221 is to be protected from the powder and/or other particles ejected in random and/or uncontrolled motions, including during the scanning cycle. As described further in the present disclosure, radiation collector 221 may use a lens for collecting UV radiation, and shielding component 246 may be configured to provide a sufficiently clear UV optical path from the weld site to radiation collector 221 even though vapor from vaporized powder, ejected powder, and other contaminants may condense on the surface of shielding component 246. Illustratively, shielding component 246 may include a UV-transparent film and/or a sacrificial lens.

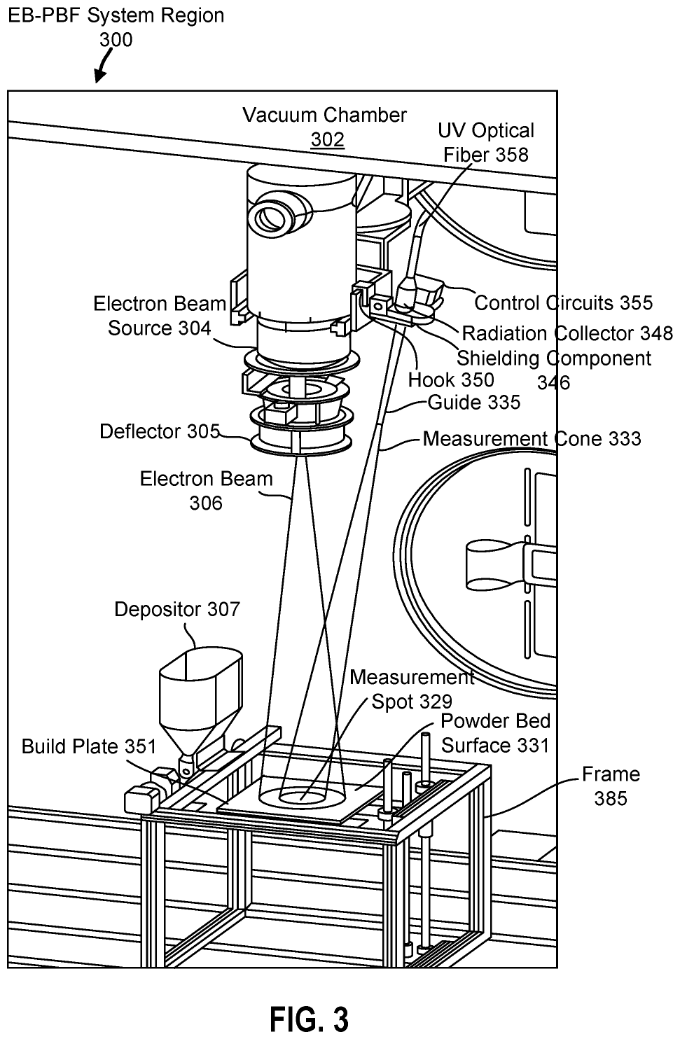

FIG. 3 is a perspective view of a region 300 of an EB-PBF system that includes a vacuum chamber 302 of an electron beam powder bed apparatus with a radiation collector 348 adjacent an electron beam source 304. Vacuum chamber 302 has been evacuated or substantially evacuated of air molecules in order to enable electron beam source 304 to scan the respective powder layers during a scanning cycle without an atmosphere obstructing its path. In addition, the absence of a substantial atmosphere (if any) prevents the powder particles from engaging in unwanted chemical reactions with air molecules, such as oxidation. Electron beam source 304 includes one or more deflectors 305 (e.g., as described above) for steering an electron beam 306 to a powder bed surface 331 at a measurement spot 329, which may be determined by the print controller or other code or logic during the scan. As illustrated, measurement spot 329 coincides with incident electron beam 306 at the powder bed surface (e.g., the weld site), although this need not be the case. It will be appreciated that the components in FIG. 3 are not necessarily drawn to scale, and the area of a build plate 351 and the powder bed surface 331 may be substantially larger in practical applications.

The powder bed in the illustrated embodiment is supported at least in part by a frame 385. A depositor 307 may deposit a layer of powder during each re-coat cycle. Build plate 351 may be moved downward to accommodate a larger build piece and, in some embodiments, to maintain electron beam source 304 at a generally constant distance from powder bed surface 331.

FIG. 3 further illustrates radiation collector 348, which can collect radiation from powder bed surface 331 at UV wavelengths. In various embodiments, radiation collector 348 uses a lens or a UV-transparent material or another material to enable UV wavelengths to pass through. Potentially, electromagnetic radiation of non-UV wavelengths may also pass through, in which case UV optical components can further divide the UV radiation into UV wavelengths or ranges thereof, while rejecting non-UV wavelengths.

Radiation collector 348 may be proximate and/or connected on one end to a shielding component 346, which operates to protect the radiation collector (e.g., lens or other UV-transparent material) from the buildup of condensation due to the potentially chaotic environment of vacuum chamber 302 when energy levels are high due to the scanning of electron beam 306. For example, shielding component 346 may include at least one protective or sacrificial layer, which may include a UV-transparent material and may or more not be transparent to other spectra.

Shielding component 346 may be connected to control circuits 355 and/or to a dedicated processor which controls the shielding component to provide a satisfactorily clear (e.g., clear or nearly clear) UV optical path from measurement spot 329 to radiation collector 348, e.g., at different times and/or different conditions. For example, shielding component 346 may be configured to replace a current section of a protective or sacrificial layer with a clean (e.g., new or cleaned) section of the protective or sacrificial layer, e.g., at predetermined intervals and/or when control circuits 355 (or dedicated processor) determines that the current section of protective or sacrificial layer is insufficiently clean (i.e., dirty). To provide such a protective or sacrificial layer, shielding component 346 may recycle sections of UV-transparent materials, such as by cleaning dirty sections, or the shielding component 346 may discard (e.g., sacrifice) dirty sections of UV-transparent materials in order to use a new section at each replacement period.

However, the shielding component 346 may refrain from providing a clear UV optical path from measurement spot 329 to radiation collector 348 during times that radiation collector 348 is not configured to collect radiation, e.g., including recoat cycles and/or some electron beam scanning cycles from which UV radiation information is unnecessary. For example, shielding component 346 may be configured to leave a dirty section of protective or sacrificial material positioned over radiation collector 348. In another example, shielding component 346 may position another protective or sacrificial layer over the protective or sacrificial layer providing the clear UV optical path (e.g., between measurement spot 329 and radiation collector 348).

In an example embodiment, a hook 350 may connect radiation collector 348 to the electron beam source 304, which may maintain radiation collector 348 at a position relatively proximate to electron beam 306 and may facilitate an unobstructed UV optical path to measurement spot 329. Further, radiation collector 348 may be angled so that the UV optical path of radiation collector 348 traverses inside electron beam 306 and is coincident at powder bed surface 331, resulting in measurement spot 329. Accordingly, it may be desirable to configure shielding component 346 to be continuously positioned between radiation collector 348 and powder bed surface 331, thereby protecting radiation collector 348 (e.g., preventing condensation of particles on radiation collector 348) during every scanning cycle that radiation collector 348 is configured to collect radiation.

In some further embodiments, shielding component 346 may include one or more opaque components, which may be configured to cover or otherwise occupy the position between radiation collector 348 and powder bed surface 331 when radiation collector 348 is not collecting radiation. In some embodiments, radiation collector 348 may be angled away from electron beam source 304, such as being pointed to a region of vacuum chamber 302 that is substantially away from measurement spot 329. For example, radiation collector 348 may be angled in an upward direction or side direction when refraining from collecting radiation, but may be angled in a downward direction when collecting radiation.

In one embodiment, radiation collector 348 may include a guide 335 that can be used to minimize the aperture size for receiving the UV radiation and/or to assist in focusing the radiation collector. The resulting measurement cone 333, which represents the radiation (of all spectra) received at the input of guide 335, travels up to radiation collector 348 and strikes radiation collector 348 (e.g., at a lens or other UV-transparent material). Thereafter, the resulting UV radiation may be focused on a UV optical fiber 358 or another designated focal point structure. The UV radiation can travel through the UV optical fiber 358 to a processor and/or other circuitry. One advantage of measuring UV radiation is that, unlike with some high frequency measurements (e.g., X-rays) where the energy of the radiation is too high to allow routing through a wave guide, such as a fiber optic cable, the energy levels in the UV spectrum allow UV radiations to be routed to additional circuitry outside vacuum chamber 302, thereby reducing the time and complexity commensurate with routing signals and/or radiation outside the vacuum chamber.

FIG. 4 is a cross-sectional perspective view of a UV system 400 having a radiation collector 448 for use in a vacuum chamber of an EB-PBF system. The cross-section in this view effectively shows a semi-circular cutoff inside radiation collector 448. UV system 400 has a barrel portion 456 through which radiation input from a powder bed is guided, and barrel portion 456 may form a solid external sensor surface. Radiation collector 448 collects radiation 491 input from the vacuum chamber. UV system 400 also includes a lens 440. In some embodiments, radiation collector 448 uses lens 440 to selectively collect UV radiation received from a designated portion of the powder bed surface. The lens concentrates input radiation 491 onto a UV optical fiber 458, which may be housed within an external sheath (obscured for simplicity) to form a fiber optic cable for carrying the input radiation out of the vacuum chamber to electronics where the radiation can be further processed. UV system 400 may also include a hook 450 and a pivot 451 to enable UV system 400 to hang on a ledge (see, e.g., FIG. 3) and to be properly angled.

Radiation collector 448 further includes shielding component 446. Shielding component 446 may be controlled by control circuit 478, e.g., positioned adjacent radiation collector 448. For example, when shielding component 446 is engaged, the shielding component may slide laterally to cover lens 440. While shielding component 446 is shown in FIG. 4 as a generally flat structure, shielding component 446 may be connected to control circuit 478 to receive control signals. Shielding component 446 may also include additional and/or different structures in other embodiments.

Control circuit 478 includes a cover inside of which a user can obtain access to settings 484 used by the control circuit 478. In some embodiments, control circuit 478 further includes a processor for controlling the angle and activity of radiation collector 448 and/or shielding component 446. In other embodiments, these tasks are relegated to a processor outside the vacuum chamber.

Control circuit may also include a control input/output (I/O) interface 463 for communicating with a controller (see, e.g., controller 214 of FIG. 2). In some embodiments, I/O interface 463 may receive instructions from the print controller, or from another processor, and control circuit 478 may use the obtained instructions to manipulate radiation collector 448 and shielding component 446 as necessary. The instructions provided to I/O interface 463 may relate to the timing that radiation collector 448 is to be active, the cycle of activity, the angle and position of the radiation collector 448 if the radiation collector's motion is automatedly controlled, the motion and activity of shielding component 446, and other such operations.

In one embodiment, shielding component 446 is operative to cover lens 440 with a UV-transparent layer during an electron beam scanning cycle, thereby providing and maintaining a UV optical path to a measurement spot at a powder bed surface that is unobstructed and free from containments at least as much as is necessary to accurately collect radiation emitted at the powder bed surface. In some embodiments, shielding component 446 can include one or more other layers configured to protect both the UV-transparent layer and lens 440 during time periods that radiation collector 448 is not configured to collect input radiation 491. In some embodiments, shielding component 446 may be configured to rotate or pivot to protect lens 440 and UV transparent layer during time periods that radiation collector 448 is not configured to collect input radiation 491.

In some other embodiments, UV system 400 may include another interface 463 to the control circuit/processor 478. In still other embodiments, radiation collector 448 may use a different type of structure as a focal point for input radiation 491. The processing equipment and circuits for UV system 400 may be integrated as part of one main unit within the vacuum chamber, with inputs and outputs fed through a chamber feedthrough to and from the print controller and/or other locations. In various embodiments, radiation collector 448 may receive UV radiation, which can then be routed via a single fiber optic cable and fed through interface from the vacuum chamber to a region external to the vacuum chamber for processing. An advantage of the latter embodiment is that the conditions are more likely to represent standard temperatures and pressures, meaning that the circuits are more likely to function properly and less likely to degrade over time as a result of high temperatures and energetic atomic level phenomena in the vacuum chamber.

FIG. 5 is a block diagram illustrating an example EB-PBF system 500, which includes a radiation collector 548 coupled to a shielding component 546 in a vacuum chamber 502 and an external processor 564 that receives UV radiation via a UV optical fiber cable 555 and a feed-through interface 562. In this view, vacuum chamber 502 includes a build plate 551 of the PBF system (not drawn to scale), which is operative to receive deposited powder layers to print an object. For clarity, the electron beam source and other components specific to the printing capabilities are omitted from the diagram. Underneath radiation collector 548 is shielding component 546 for protecting the radiation collector while simultaneously providing a clear UV optical path to the weld site or measurement spot. While shielding component 546 is illustrated as blocking radiation collector 548, shielding component 546 may be UV-transparent and/or may include an aperture (obscured from view) for allowing UV radiation from a powder bed surface to be collected at the input of radiation collector 548. In some embodiments, shielding component 546 may be moved horizontally by a sufficient amount to allow radiation to pass to the radiation collector. The powder bed surface is supported by build plate 551 and powder bed walls, the latter of which in some embodiments may be the vacuum chamber walls described in FIGS. 1A-D.

A measurement cone 533 represents the field of view of radiation collector 548 to the weld site from which UV radiation is collected. Radiation collector 548 may use a lens or other UV-transparent material to concentrate the collected UV radiation onto a focal point, and fiber optic cable 555 carries the UV radiation initially through a feed-through interface 562 built into a vacuum chamber wall 558. Feed-through interface 562 is carefully sealed to retain the vacuum in vacuum chamber 502 and to allow only the fiber optic cable 555 to pass through. Feed-through interface 562 may include a seal that may be implemented using a suction apparatus, adhesive, or similar mechanism, thereby ensuring separation between the vacuum chamber 502 and the outer atmospheric pressure region 567, which is any area of the system external to the vacuum chamber 502 that is at ordinary atmospheric pressure conditions. In some embodiments, fiber optic cable 555 passes collected radiation to a processor 564.

In one embodiment, processor 564 is a dedicated processor that is separate from, but connected via electrical connections to, the print controller 214 (FIG. 2). In other embodiments, the processors may be the same, with dedicated code in the print controller used for control. Processor 564 includes three components in the illustrated embodiment. A first example component of processor 564 may include a receiver interface 573, which may be configured to provide UV radiation to other components of processor 564 based on radiation carried on fiber optic cable 555. In one embodiment, receiver interface 573 may include a WD mux/demux. The WD mux/demux may be configured to extract specific UV wavelengths or spectral bands of select UV wavelengths from the input radiation source, which source may include the entire input UV array and, potentially, other spectra that may not have been previously filtered out, e.g., by radiation collector 548 and/or shielding component 546. In some embodiments, the receiver interface 573 may be configured to extract those specific UV wavelengths or spectral bands based on the power material provided at the powder bed surface. For example, receiver interface 573 may be configured to extract different UV wavelengths or spectral bands for different alloy compositions. In other embodiments, receiver interface 573 may be configured to select radiation of the entire UV spectrum from input radiation (e.g., including radiation in other spectra) carried on fiber optic cable 555. It should be understood that, while receiver interface 573 is shown herein as being part of processor 564, receiver interface 573 may be a separate circuit and need not be integrated within processor 564. In some embodiments, filters or other types of circuits may be used in place of a WD mux/demux in receiver interface 573.

A second example component of processor 564 includes electronic sensors 575. Electronic sensors 575 may include, among other components, a transducer for converting the selected UV radiation to an electrical signal, having the same frequency characteristics, phase, and relative amplitudes of the corresponding radiation. In other embodiments, the transducer stage may come before the WD mux/demux of receiver interface 573. That is to say, these functions may be performed in different sequences in different embodiments, e.g., depending in part on the type of circuits and structures used. Further, electronic sensors 575 may be configured to analyze the radiation (or converted electrical signal) and obtain from the radiation (or converted electrical signal) one or more measurements and/or other data, such as material composition, interactions between powder and trace atmosphere or other trace interactions, interactions between electron beam and powder material, process states, and/or a representative model of the frequency spectrum/frequency characteristics of the UV radiation.

A third example component of processor 564 is a control unit or CPU 578 that may further analyze the information from electronic sensors 575. In some embodiments, CPU 578 may also execute code for tracking resonant peaks of the input UV radiation in the UV (or visible) spectrum, mapping or graphing the input UV radiation in the UV spectrum, and/or performing other measurements on the input UV radiations. For example, resonant peaks may be representative of the material composition used in the build process and/or may be representative of other process states, such as interactions between electron beams and materials. CPU 578 may include a discriminator that is applied to resonant peaks and/or other maps/graphs in the UV spectrum derived from input UV radiation. CPU 578 may further directly or indirectly obtain other information from the UV spectrum, e.g., including total energy. CPU 578 may also analyze this information as a function of time in lieu of, or in addition to, frequency. CPU 578 may store some or all of the foregoing information in memory, e.g., for future use and/or comparison purposes.

Based on some or all of the foregoing information (e.g., resonant peaks or other measurements), CPU 578 may determine printer parameters and/or control signals to be used for quality monitoring in determining deviations of material compositions. In some embodiments, CPU 578 may use a set of mathematical and/or heuristics functions applied to some or all this information (e.g., resonant peaks or other measurements) to derive various control signals, which may be subsequently applied to adjust one or more printer parameters, e.g., on a layer-by-layer basis or on a continuous basis. Such control signals may be designed to increase material properties and ensure consistency in the build process. In some embodiments, CPU 578 may pass this information to controller 214 (FIG. 2), which may perform similar tasks. CPU 578 may evaluate different regions of the powder bed, and synthesize this information to determine printer parameters and/or control signals.

Another example function of CPU 578 is to provide instructions to receiver interface 573 and/or electronic sensors 575. That is, the actions of electronic sensors 575 may be facilitated and/or controlled by CPU 578. CPU 578 may include any suitable type of control unit, digital signal processor (DSP), and/or other general purpose or dedicated processing or control unit within processor 564. In some embodiments, each of these three components 573, 575 and 578 are separate, and not integrated as a single processor. For example, the CPU 578 may be a separate processor built into a circuit to provide control signaling and/or to act as an input/output interface for remaining portions of the PBF system. Processor 564 may receive, at the CPU 578, instructions from the print controller 214 to perform one or more actions with respect to the input UV radiation and/or to elicit specific types of information from the input UV radiation.

It will be understood by those skilled in the art on perusal of this disclosure that controllers/processors 214, 564 may be executed from a personal computing device, server device, and/or other computer positioned adjacent to or networked to the PBF system. Thus, while a single processor or a plurality of dedicated processors may be integrated into the PBF system, other circuits, processors, computers, or CPUs may provide additional instructions.

Referring still to FIG. 5, in other embodiments, the processor 564 may make one or more of these determinations (e.g., regarding whether to change some parameter or issue some control signaling, e.g., adjusting beam intensity, scanning rate, deposition speed, and/or to inject a waiting time until the system cools down, etc.) in concert with the print controller or in isolation. If in isolation, processor 564 may transmit requests to the print controller to modify the beam intensity, scanning speed, provide waiting time until the next scan, and the like. In still other embodiments, the print controller can perform these determinations based on information or requests received from the electronic sensors 575 of processor 564.

FIG. 6 illustrates an example radiation collector for collecting UV radiation, receiver interface for extracting one or more wavelengths from the UV radiation, and an electronic sensor for converting the extracted wavelengths of the UV radiation into an electrical signal for further processing. The radiation collector can include a lens 613 for collecting UV radiation 612 from a surface of the powder bed. In some embodiments, a selected UV transparent material may be used. In other embodiments, multiple sacrificial and focusing elements may be implemented. The sacrificial elements can be partially opaque. The sacrificial elements may initially reject very high energy wavelengths, for example, and the focusing elements (e.g., lens 613) can concentrate UV radiation onto a diffraction grating 614, which in an example of a receiver interface for extracting one or more wavelengths from the UV radiation.

In other embodiments, the lens 613 can be positioned at an angle to receive diffracted UV spectra from the diffraction grating, where it can then focus radiation onto a UV optical fiber. In the embodiment shown, the diffraction grating 614 diffracts a spectrum of the received radiation, including the UV radiation, onto a surface of the photodiode array 621, which is an example of an electronic sensor for converting UV radiation into an electrical signal. In some embodiments, multiple lenses or sections of UV transparent or sacrificial material may be used. At photodiode array 621, a plurality of individual photodiodes 611a-c can be used to convert the extracted wavelengths of the UV radiation into electrical signals for use by processor 564 (or, in other embodiments, controller 214 (FIG. 2).

FIG. 6 represents one example for collecting radiation, selecting UV radiation, and converting the UV radiation to electrical signals. In some embodiments where all the circuits are closely integrated, the need for a longer UV optical fiber cable can be eliminated and the output of the photodiode array 621 can be routed directly to processor 564 (FIG. 5) or controller 214 (FIG. 2). The components in FIG. 6 are not necessarily drawn to scale, and other orientations of the components, with additional components to process the UV radiation from the diffraction grating 614, are possible.

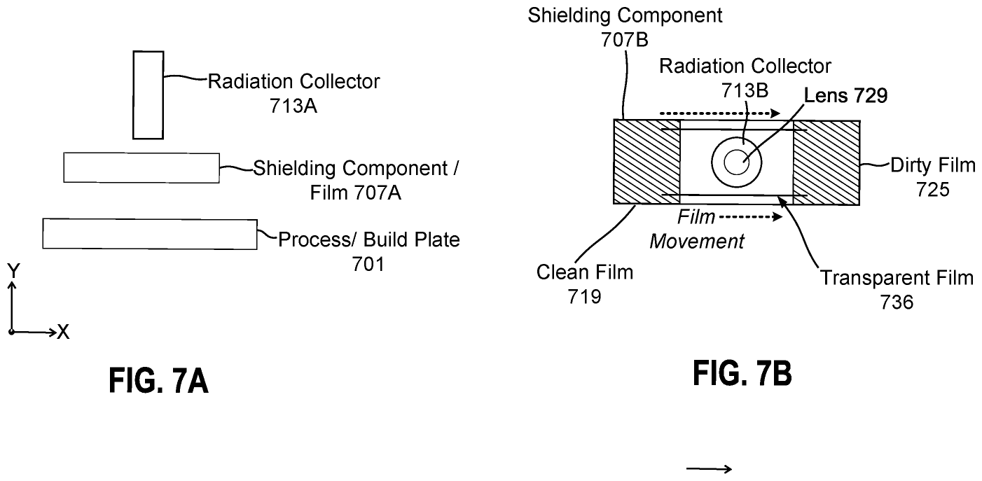

FIGS. 7A-B illustrates example embodiments of a radiation collector coupled to a shielding component for selectively receiving UV radiation. FIG. 7A illustrates a basic orientation and printer/optical elements. For instance, a shielding component and UV-transparent film configuration 707A are collectively positioned above the build plate 701 so that measurements can be taken from the powder bed surface of the EB-PBF printer. Radiation collector 713A is connected or proximate to shielding component and film configuration 707A, e.g., collectively including UV-transparent and/or sacrificial elements.

FIG. 7B shows an example of a radiation collector 713B coupled to a shielding component 707B. Radiation collector 713B includes a lens 729 for concentrating UV radiation collected from the powder bed surface onto another element, such as a portion of a UV optical fiber. Proximate or connected to radiation collector 713B, a shielding component 707B includes a UV-transparent film 736 for receiving UV wavelengths (e.g., selectively or in addition to other wavelengths). Shielding component 707B houses UV-transparent film 736 (and may house or otherwise support at least a portion of radiation collector 713B). UV-transparent film 736 starts out as a clean, unexposed film section 719 underneath the left side of shielding component 707B. Clean film section 719 is masked from exposure to radiation by shielding component 707B in order to prevent exposure to contaminants or other elemental condensation that would reduce its efficacy in protecting radiation collector 713B. Meanwhile, a section of UV-transparent film 736 currently aligned with radiation collector 713B may be used to protect radiation collector 713B when collecting UV radiation.

The structure of FIG. 7B is operative to avoid the buildup of excessive condensation on any given section of film 736. Thus, whether periodically in a predetermined time interval or dynamically at a processor-controlled rate, the circuits of shielding component 707B advance another section of the film 736 into alignment with radiation collector 713B to expose a new region of the UV transparent film 736. Stated differently, shielding component 707B and/or related circuitry feeds the film in a direction to the right to expose a new section. The current UV transparent film section under lens 729 is, as a result, advanced into a masked position on the right of the apparatus at a right side of shielding component 707B, wherein it can be designated “dirty film” 725. In some embodiments, dirty film 725 can subsequently be cleaned from any condensation or other contaminants to which it was exposed while being used. Then, after another predetermined time interval or as governed by processor instructions, the shielding component 707B again advances film 736 to move a new, previously unexposed section from the left part of shielding component 707B into alignment with radiation collector 713B. This process can be repeated as long as there is film 736 remaining in the apparatus and/or in perpetuity if dirty film 725 is cleaned and returns to the position of clean film 719 (e.g., as in a circular roll). The process of advancing UV-transparent film 736 can repeat in this manner during a print job to maximize accuracy of the received UV radiation, thus increasing the robustness and precision of measuring or otherwise tracking resonant peaks in UV radiations.

The apparatus of FIG. 7B advantageously maximizes the accuracy of UV spectral readings by using a given section of film over the lens for a period of time after which a new section is provided. A processor can also cause the shielding component 707B to speed up the advancement of the film sections, for example, at higher risk areas such as when radiation collector 713B is collecting radiation during the scanning cycle when immediately above the surface being scanned, or for other reasons. Meanwhile, during re-coat cycles and other times at which radiation collector 713B is not collecting UV radiation, for instance, the processor may opt to slow or stop the advancement of film 736 to preserve the lifespan of film 736, with minimal risks of condensation of particles affecting collecting and measurements.

In various embodiments, the UV transparent film can be formed as a “cartridge” similar to a toner cartridge. The cartridge can be inserted into the shielding component 707B for easy replacement when the film in the existing cartridge is used. In some embodiments, shielding component 707B or radiation collector 713B may be part of the replacement cartridge itself.

As described herein, a lens can concentrate radiation onto a UV optical fiber, and a WD mux/demux can obtain UV wavelengths. With the UV wavelength information carried to it by the UV optical fiber, the processor can determine any number of characteristics in the UV wavelengths. While some embodiments of a radiation collector may include a single lens for focusing UV radiation onto on a UV optical fiber, more complex radiation collectors are also within the scope of the present disclosure.

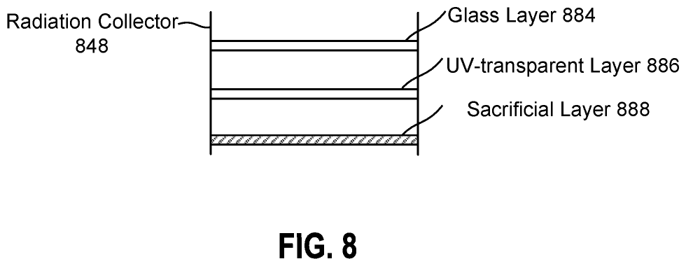

FIG. 8 shows a front view of a more complex radiation collector 848, which includes a glass layer 884, a UV-transparent layer 886, and a sacrificial layer 888 for collecting radiation. Layers 884, 886, 888 may illustrate stacked elements and multiple lens configurations to collect UV radiation. The top-most and/or upper layer may be glass layer 884. Adjacent glass layer 884 may be UV-transparent layer 886, which may be used to broadly admit UV wavelengths. To improve the accuracy of radiation collector 848 and reject non-UV wavelengths, sacrificial layer 888 may be stacked underneath UV-transparent layer 886 to “fine tune” UV-transparent layer 886 and reject extraneous non-UV wavelengths. Thus, sacrificial layer 888 may be the bottom-most and/or outer layer of radiation collector 848. Other layers may be used, such as a separate lens that is optimized for focusing the received radiation onto a designated focal point or a diffraction grating.

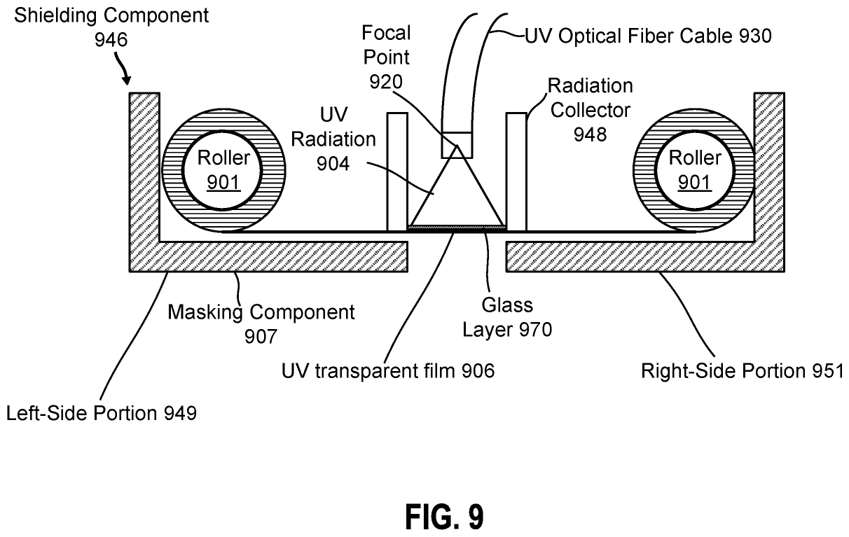

FIG. 9 illustrates a view of another example configuration of a radiation collector 948 and shielding component 946, in accordance with different embodiments. This embodiment uses concepts articulated above with reference to FIG. 7B, and represents one technique for progressively advancing new sections of film to align with the radiation collector. For example, radiation collector 948 can be configured in the center of the apparatus, with shielding component 946 including a masking component 907 having a left-side portion 949 for masking new UV-transparent film 906, and another right-side portion 951 for masking used UV-transparent film. In various embodiments, right-side portion 951 of masking component 907 is not used. To enable streamlined use of a continuous supply of UV-transparent film 906, the film is selected to be flexible such that it can be rolled without damage. Two rollers 901 are used to progressively feed, e.g., under processor control, UV-transparent film 906 so that periodically, new sections are exposed to align with a glass layer 970 of radiation collector 948. Glass layer 970 or other lens may protect the remaining portions of radiation collector 948 in some embodiments. The lens may also concentrate UV radiation 904 on a focal point 920 of a UV optical fiber cable 930. In other configurations, only one roller is used.

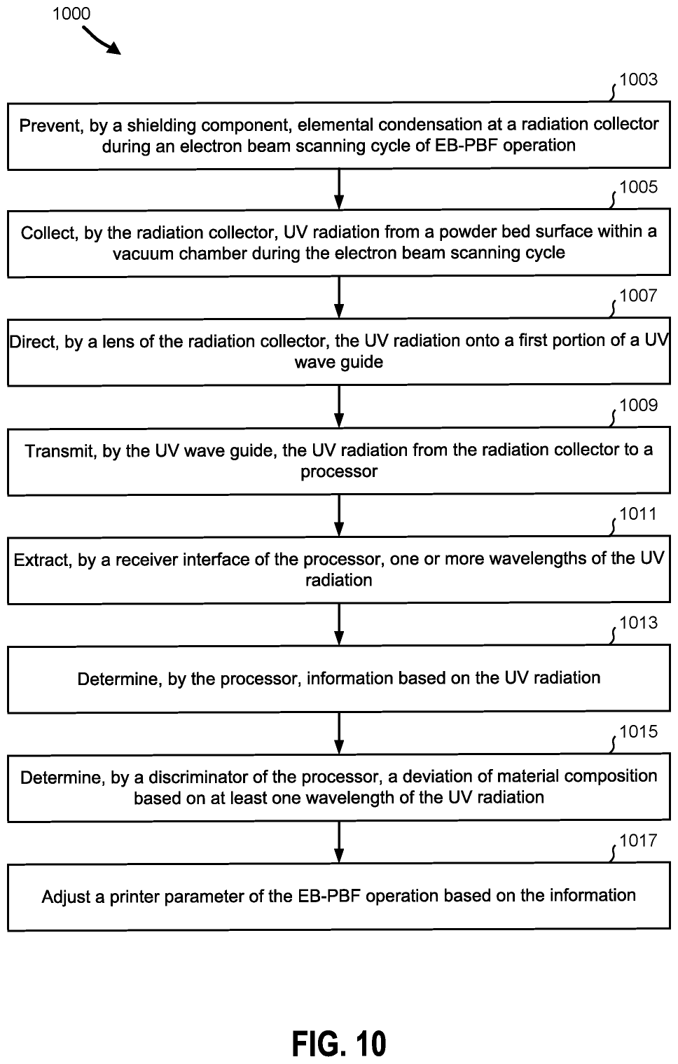

Referring to FIG. 10, a flow chart illustrates an example method 1000 of sensing UV radiation in an EB-PBF system. Method 1000 may be performed by a PBF apparatus, such as PBF apparatus 200 of FIG. 2 and/or an EB-PBF system, such as example region 300 of an EB-PBF system FIG. 3 communicatively connected to a processor and/or controller and/or EB-PBF system 500 of FIG. 5. According to different embodiments, one or more of the example operations of method 1000 may be omitted, transposed, and/or contemporaneously performed.

In various embodiments of method 1000, one or more layers of powder composed of a material (e.g., a metal alloy) may be provided at a power bed surface within a vacuum chamber. A controller/processor may be configured to control an electron beam source to generate an electron beam that strikes the powder (e.g., at a weld site) in order to fuse one or more layers of powder into a build piece, for example, as the controller/processor controls the movement of the electron beam across the powder bed surface using a deflector. Periods during which the electron beam strikes the powder and causes fusing may be referred to as “electron beam scanning cycles” or simply “scanning cycles,” whereas periods during which the electron beam does not strike the surface, such as when a depositor provides a new layer of powder at the power bed surface, may be referred to as “recoat cycles.” The EB-PBF system may alternate between electron beam scanning cycles and recoat cycles until EB-PBF operation is complete, which may occur when the build piece is completed.

During an electron beam scanning cycle of EB-PBF operation, a shielding component may prevent elemental condensation at a radiation collector (1003). For example, the shielding component may mask a first section of a UV-transparent material (e.g., UV-transparent film) when a second section of the UV-transparent material prevents the elemental condensation at the radiation collector during the electron beam scanning cycle. Subsequently, the shielding component may be configured to replace the second section of the UV-transparent material with the first section, such that the first section is unmasked when replacing the second section. The shielding component may be configured to replace the second section with the first section at a predetermined time or periodic interval and/or may be configured to replace the second section with the first section by a controller/processor. Accordingly, the shielding component may prevent, via the first section of the UV-transparent material, elemental condensation at the radiation collector during another electron beam scanning cycle, such as the next consecutive scanning cycle or another subsequent scanning cycle.

Also during the electron beam scanning cycle of EB-PBF operation, the radiation collector may collect UV radiation from the powder bed surface within the vacuum chamber of the EB-PBF printer (1005). A lens of the radiation collector may direct the UV radiation onto a first portion of a UV wave guide, which may be transparent to the UV radiation (1007). The UV wave guide may transmit the UV radiation from the radiation collector to a processor (1009). A receiver interface of the processor may be configured to extract one or more wavelengths of the UV radiation (1011). In some embodiments, the receiver interface is configured to select at least one wavelength of the extracted one or more wavelengths based on a powder of the powder bed surface.

The processor may determine information based on the UV radiation (1013). In some embodiments, a discriminator of the processor may determine a deviation of material composition based on at least one extracted wavelength of the UV radiation (1015). For example, the discriminator may determine the deviation based on the selected at least one wavelength selected by the receiver interface. The processor may be configured to a printer parameter of the EB-PBF operation based on the information (1017). The printer parameter may include at least one of an intensity of an electron beam, a focus of the electron beam, a rate of electron beam scanning, a type of electron beam scanning, and/or a height of the powder bed. For example, the processor may include UV-sensitive electronics configured to track resonant peaks in the UV and/or lower-adjacent visible spectrum, and the resonant peaks may be representative of material composition and/or process states (e.g., interactions between the electron beam and the material of the powder and/or trace atmosphere interactions). The one or more EB-PBF operations controlled by the processor based on the extracted one or more wavelengths of the UV radiation may be during manufacture of the same build piece and/or may be during manufacture of a later build piece. In some embodiments, a controller of the processor may adjust a printer parameter of the EB-PBF operation based on one or more extracted wavelengths of the UV radiation.

In some embodiments, the processor may be configured to control the one or more EB-PBF operations by determining a deviation of material composition based on the UV radiation, e.g., for quality control and to ensure consistency in the build process. For example, the processor may include or may be connected to a discriminator configured to determine whether deviations from material composition is within acceptable tolerances based on the UV radiation. In some other embodiments, the processor may be configured to control the one or more EB-PBF operations by adjusting one or more printer parameters of EB-PBF operation based on applying at least one mathematical function and/or at least one heuristic function to the UV radiation, which may maximize material properties. For example, the processor may generate control signals based on the UV radiation, which the processor may then apply to alter various printer parameters on a layer-by-layer basis and/or on a continuous basis.

The previous description is provided to enable any person skilled in the art to practice the various aspects described herein. Various modifications to these example embodiments presented throughout this disclosure will be readily apparent to those skilled in the art. Thus, the claims are not intended to be limited to the example embodiments presented throughout the disclosure, but are to be accorded the full scope consistent with the language claims. All structural and functional equivalents to the elements of the example embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus for an electron-beam powder bed fusion (EB-PBF) printer, comprising:
a radiation collector configured to collect ultraviolet (UV) radiation from a powder bed surface within a vacuum chamber during an electron beam scanning cycle of EB-PBF operation; and
a processor configured to determine information based on the UV radiation.

2. The apparatus of claim 1, further comprising:
a UV wave guide configured to transmit the radiation from the radiation collector to the processor.

3. The apparatus of claim 1, wherein the radiation collector comprises a lens configured to direct the UV radiation onto a first section of the UV wave guide.

4. The apparatus of claim 1, wherein the radiation collector further comprises at least one of one or more sacrificial components or one or more focusing components via which the UV radiation is received by the UV wave guide.

5. The apparatus of claim 1, further comprising:
a shielding component configured to prevent elemental condensation at the radiation collector during the electron beam scanning cycle, the shielding component being transparent to at least the UV radiation.

6. The apparatus of claim 5, wherein the shielding component comprises:
a plurality of sections of UV-transparent material; and
a masking component configured to mask a first section of the UV-transparent material when a second section of the UV-transparent material prevents the elemental condensation at the radiation collector during one stage of the EB-PBF operation, wherein the shielding component is configured to advance the first section to replace the second section during another stage of the EB-PBF operation.

7. The apparatus of claim 1, further comprising:
a feed-through interface via which the UV wave guide is configured to transmit the UV radiation outside of the vacuum chamber.

8. The apparatus of claim 1, wherein the processor comprises a receiver interface configured to extract one or more wavelengths of the UV radiation.

9. The apparatus of claim 8, wherein the receiver interface is configured to select at least one wavelength of the extracted one or more wavelengths based on a powder of the powder bed surface.

10. The apparatus of claim 9, wherein the processor further comprises a discriminator configured to determine a deviation of material composition based on the selected at least one wavelength.

11. The apparatus of claim 8, wherein the processor further comprises a controller configured to adjust a printer parameter of the EB-PBF operation based on the one or more extracted wavelengths.

12. The apparatus of claim 1, wherein the processor is further configured to adjust printer parameter of the EB-PBF operation based on the information.

13. The apparatus of claim 12, wherein the printer parameter includes at least one of an intensity of an electron beam, a focus of the electron beam, a rate of electron beam scanning, a type of electron beam scanning, or a height of the powder bed.

14. A PBF apparatus, comprising:
an electron beam source configured to selectively fuse at least one layer of powder of a powder bed in a vacuum chamber; and
an optical assembly within the vacuum chamber and including:
a radiation collector configured to collect ultraviolet (UV) radiation from the at least one layer of powder when the electron beam source selectively fuses the at least one layer of powder,
a UV-transparent optical fiber configured to receive the UV radiation from the radiation collector, and
at least one interface configured to provide the UV radiation to a processor of the PBF apparatus.

15. The PBF apparatus of claim 14, wherein the processor is configured to measure the UV radiation.

16. The apparatus of claim 14, wherein the processor is further configured to determine, based on the measurement of the UV radiation, at least:
a process state associated with the PBF apparatus, or
composition information associated with the powder.

17. The PBF apparatus of claim 14, wherein the processor is provided at region of the PBF apparatus that is outside of the vacuum chamber.

18. The PBF apparatus of claim 14, wherein the optical assembly further includes at least one lens configured to focus the UV radiation on the UV-transparent optical fiber.

19. The PBF apparatus of claim 18, wherein the optical assembly further includes at least one UV-transparent film configured to protect the at least one lens when the electron beam source selectively fuses the at least one layer of powder.

20. The PBF apparatus of claim 19, wherein a first section of the UV-transparent film is configured to protect the at least one lens when the electron beam source selectively fuses the at least one layer of powder, and a second section of the UV-transparent film is configured to replace the first section to protect the at least one lens when the electron beam source selectively fuses at least one other layer of powder.

21. The PBF apparatus of claim 14, wherein the UV-transparent optical fiber is configured to carry the UV radiation out of the vacuum chamber to the processor via the at least one interface.

22. The PBF apparatus of claim 14, wherein the at least one interface comprises a wavelength-division de-multiplexor configured to extract at least one wavelength from the UV radiation.

23. The PBF apparatus of claim 22, wherein the at least one interface comprises a discriminator configured to determine a deviation of material composition based on the extracted at least one wavelength.

24. The PBF apparatus of claim 22, wherein the at least one wavelength is based on a type of the powder.

25. The PBF apparatus of claim 14, wherein the radiation collector is configured to receive a plurality of UV radiation at different regions of the surface at which the at least one layer of powder is provided.

26. A method for an electron-beam powder bed fusion (EB-PBF) printer, comprising:
collecting, by a radiation collector, ultraviolet (UV) radiation from a powder bed surface within a vacuum chamber during an electron beam scanning cycle of EB-PBF operation; and
determining, by a processor, information based on the UV radiation.

27. The method of claim 26, further comprising:
transmitting, by a UV wave guide, the UV radiation from the radiation collector to the processor.

28. The method of claim 26, further comprising:
directing, by a lens of the radiation collector, the UV radiation onto a first section of the UV wave guide.

29. The method of claim 26, wherein the radiation collector further comprises at least one of one or more sacrificial components or one or more focusing components via which the UV radiation is received by the UV wave guide.

30. The method of claim 26, further comprising:
preventing, by a shielding component, elemental condensation at the radiation collector during the electron beam scanning cycle, the shielding component being transparent to at least the UV radiation.

31. The method of claim 30, wherein the shielding component comprises:
a plurality of sections of UV-transparent material; and
a masking component configured to mask a first section of the UV-transparent material when a second section of the UV-transparent material prevents the elemental condensation at the radiation collector during one stage of the EB-PBF operation,
wherein the shielding component is configured to advance the first section to replace the second section during another stage of the EB-PBF operation.

32. The method of claim 26, wherein the UV wave guide is configured to transmit the UV radiation outside of the vacuum chamber via a feed-through interface.

33. The method of claim 26, further comprising:
extracting, by a receiver interface of the processor, one or more wavelengths of the UV radiation.

34. The method of claim 33, wherein the receiver interface is configured to select at least one wavelength of the extracted one or more wavelengths based on a powder of the powder bed surface.

35. The method of claim 34, further comprising:
determining, by a discriminator of the processor, a deviation of material composition based on the selected at least one wavelength.

36. The method of claim 33, further comprising:
adjusting, by a controller, a printer parameter of the EB-PBF operation based on the extracted one or more wavelengths.

37. The method of claim 26, further comprising:
adjusting, by the processor, a printer parameter of the EB-PBF operation based on the information.

38. The method of claim 37, wherein the printer parameter includes at least one of an intensity of an electron beam, a focus of the electron beam, a rate of electron beam scanning, a type of electron beam scanning, or a height of the powder bed.
